(19) United States
(12) Patent Application Publication
(10) Pub. No.: US 2021/0088685 A1
(43) Pub. Date: Mar. 25, 2021

(54) MEASURING FRACTURE-HIT ARRIVAL TIME IN WELLBORE OPERATIONS

(71) Applicant: Halliburton Energy Services, Inc., Houston, TX (US)

(72) Inventor: Zhao Zheng, Cypress, TX (US)

(21) Appl. No.: 16/575,898

(22) Filed: Sep. 19, 2019

(51) Int. Cl. G01V 1/30; G01V 1/16; G01V 1/40; G01V 99/00; E21B 41/00; E21B 49/00; E21B 43/26

(52) U.S. Cl. CPC G01V 1/303; G01V 1/16; G01V 1/40; E21B 43/26; E21B 41/0092; E21B 49/00; G01V 99/005

(57) ABSTRACT

Aspects of the present disclosure relate to detecting and predicting data related to the arrival of fractures at a wellbore. The fractures arriving at the wellbore can cause borehole tube waves to form in the wellbore. Data associated with the borehole tube waves can be measured using sensors positioned in the wellbore. The data can be used to determine the arrival time of the fracture and the wellbore. The arrival time and an arrival location can be used to create a prediction model for predicting the arrival of future fractures at the wellbore.

### TECHNICAL FIELD

The present disclosure relates generally to wellbore operations. More specifically, but not by way of limitation, this disclosure relates to measuring fracture hits arriving at a wellbore.

### BACKGROUND

A common oilfield area can include multiple wellbores for extracting hydrocarbon fluid from a subterranean formation in the oilfield area. One example is a first wellbore that is drilled through the subterranean formation, completed for production, and that is producing hydrocarbon fluid at one or more production intervals of the first wellbore, while a second wellbore is drilled through the subterranean formation and being completed for production. Another example is two wellbores drilled through the subterranean formation and both are being completed for production.

Completion operations can include hydraulic fracturing, which can involve introducing fracturing fluid into the subterranean formation using pressure to increase production of hydrocarbon fluid from the formation during the production stage. A hydraulic fracturing operation in one wellbore in the oilfield area can affect the other wellbore in the oilfield area. For example, pressure from the operation or hydraulic fluid from the operation may reach the other wellbore. Such impacts can be referred to as fracture hits.

Fracture hits can negatively affect the other wellbore. But, fracture hits are difficult to detect or measure to understand the impact of fracture hits on the wellbore or to include equipment in the other wellbore to prevent the fracture hits from negatively impacting the wellbore.

### BRIEF DESCRIPTION OF THE DRAWINGS

FIG. 1 is a cross-sectional schematic view of an oilfield area with multiple wellbores in which there can be positioned data-gathering equipment according to some aspects of the present disclosure.

FIG. 2 is a block diagram of a computer system for measuring fracture hits on a wellbore according to some aspects of the present disclosure.

FIG. 3 is a flowchart of a process for receiving and processing data from the data-gathering equipment of FIG. 1 according to some aspects of the present disclosure.

FIGS. 4, 5, and 6 are graphical representations of data received from the data-gathering equipment of FIG. 1 according to some aspects of the present disclosure.

FIG. 7 is a flowchart of a process for generating and using a prediction model based on the processed data of FIG. 3 according to some aspects of the present disclosure.

FIG. 8 is a graphical representation of the data used with the prediction model of FIG. 7 according to some aspects of the present disclosure.

FIG. 9 is a cross-sectional schematic view of an oilfield area with data-gathering equipment positioned in a deviated wellbore according to some aspects of the present disclosure.

FIG. 10 is a cross-sectional schematic view an oilfield area with data-gathering equipment positioned in multiple wells according to some aspects of the present disclosure.

FIG. 11 is a flowchart of a process for using the prediction model of FIG. 7 to predict fracture hits in an oilfield area according to some aspects of the present disclosure.

### DETAILED DESCRIPTION

Certain aspects and features of the present disclosure relate to measuring fracture hits at an offset well caused by fracturing activities (e.g., hydraulic fracturing) performed in another well in a common oilfield area. The fracture hits may be fractures, pressures, or fluid, from fracturing operations in one well that impact the other well. A fracture hit can cause borehole tube waves on the impacted well. A sensor system in the impacted well can detect the borehole tube waves to measure the fracture hits. Time information, and potentially location information, for the fracture hits can be determined from measuring the borehole tube waves.

Measuring fracture hits can provide well operators with data on which to understand the impact of the well and to make decisions with respect to the well, the well in which the hydraulic fracturing operation is occurring, or another well in the oilfield area. For example, a well operator may change the pressure or fluid volume used in the fracturing operation to reduce the effect of the operation on the impacted well. The well operator may additionally or alternatively run protective equipment into the impacted well to prevent the fracture hits from negatively impacting the well. The data may also be used to predict fracture hits that may occur in the oilfield area or in similar oilfield areas.

More specifically, direct fluid hits from a passing fracture can result in borehole tube waves in a first well, which may also be referred to as an offset well. The borehole tube waves can be measured by one or more downhole sensors deployed in the first well. The sensors can include any type of downhole vibration sensor (e.g., geophones, distributed acoustical systems (DASs), downhole pressure gauges, etc.). Hundreds of borehole tube waves can be measured during a stage of fracturing actions occurring in the second well—i.e., the well in which the fracturing operation is being performed, which may also be referred to as a treatment well. The level of activity (e.g.. number of events per minute) can be measured in real time by the sensors. A sudden rise in borehole tube wave events can indicate the time of fracture arrival upon the first well. Using the distance between the first well and the second well, and the travel time of the fracture between the two wells, the fracture speed can be determined. Data collected from completed stages or jobs can be used to build a model to predict fracture arrival time for future stages or jobs. Data can also be collected from historical projects and used to validate and improve the model. For example, historical projects can be used with a machine learning based model that requires a large data set for both training and testing purposes

Some examples of the present disclosure can monitor fracture on a wellbore to cross-validate other diagnostic tools and methods. For example, fracture can be monitored and predicted for use with other tools and models providing an integrated solution with more robust and reliable predictions to assist action control.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

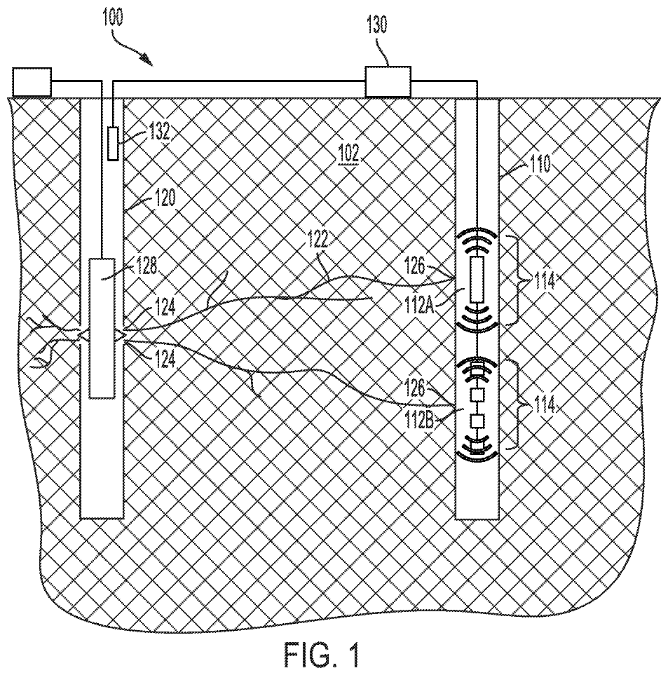

FIG. 1 shows a cross-sectional view of a well system 100 including a first well (hereinafter referred to as an “offset well”) 110 and a second well (hereinafter referred to as a “treatment well”) 120 extending through various earth strata that form a subterranean formation 102. The offset well 110 and the treatment well 120 can be vertical, deviated, horizontal, or any combination of these.

A well operator can obtain hydrocarbon fluid from the subterranean formation 102. To obtain the hydrocarbon fluid, the well operator can perform hydraulic fracturing by injecting fluid at high pressure into the subterranean formation 102. The fluid can be injected into the subterranean formation 102 using fracturing equipment 128. The high pressure of the fluid can cause stresses on the rock in the subterranean formation 102 to change, causing the rock to slip or shear along a preexisting zone of weakness (e.g., a fault) and create one or more fractures 122 along which slips can occur. In some examples, the fracture 122 can enable hydrocarbons to flow from the subterranean formation 102 into the treatment well 120 during a production stage. In some examples, a sensor system 132 can be positioned in the treatment well 120. Using one or more sensors, the sensor system 132 can detect data about the treatment well 120. For example, the sensor system 132 can detect an amount of fluid exiting the treatment well 120.

The fractures can extend from a fracture initiation point 124 at the treatment well 120, through the subterranean formation 102. Some of the fractures, or pressure or fluid from the fracturing operation, can reach a fracture landing point 126 at the offset well 110. The fractures 122, or pressure or fluid from the fracturing operation, can contact the offset well 110, vibrating the well fluid and causing borehole tube waves 114 to propagate in the offset well 110. Additionally or alternatively, other events in and around the offset well 110 can cause borehole tube waves 114 to propagate in the offset well. For example, cement cracking or shearing, casing leakage, or fluid flowing into or out of the wellbore. In some example, some or all of these events can be caused by the fractures 122 reaching the offset well 110.

The borehole tube waves 114 (so-called “sharkbites”) can be measured by one or more sensors 112 in a sensor system deployed in the offset well 110. The sensors 112 can measure the speed of the borehole tube waves 114. In some examples, the borehole tube waves 114 can travel at speeds close to the speed of sound in water (e.g., 5,000 ft./s (1524 m/s)). Additionally or alternatively, the sensors 112 can measure an amount of fluid exiting the offset well 110.

In some examples, a single sensor 112A can be positioned in the offset well 110. The single sensor 112A can be moveable along the height of the offset well 110 to measure the borehole tube waves 114 at multiple locations. However, the single sensor 112A can be located at a fixed position in the offset well 110. Additionally or alternatively, an array of sensors 112B can be positioned in the offset well 110. A portion of the array of sensors 112B can be positioned above and below a fracture landing point 126 and measure borehole tube waves 114 at various heights away from the fracture landing point 126. The array of sensors 112B can be located in the offset well 110 with a horizontal or vertical offset.

The sensors 112 and sensor system 132 can be communicatively coupled to a computer system 130 via a wired or wireless link. The wire or wireless link can correspond to or comprise a wired channel, Bluetooth, Wi-Fi, and/or other wired or wireless communication protocol. The computer system 130 can receive data and determine characteristics of the fracture hits from the borehole tube waves 114. The computer system 130 is depicted as being on the surface 106 in FIG. 1, but in other configurations the computer system 130 can be deployed elsewhere, such as remotely from the oilfield area. In various examples, the computer system 130 includes a processor, memory, a power source, and communication components for communicating with other devices.

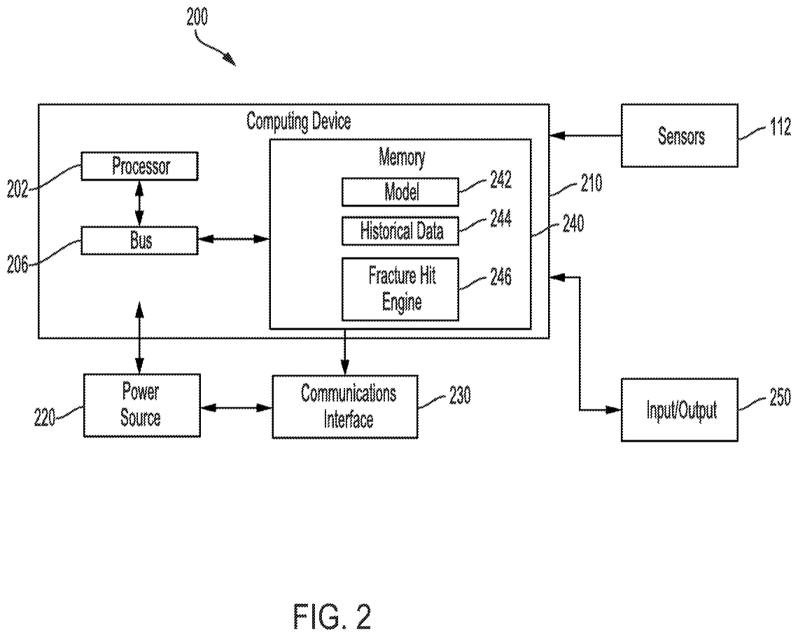

FIG. 2 is a block diagram of a computer system 200. Computer system 200 can be the same as computer system 130, however, computer system 130 can have different or equivalent components. The computer system 200 can be used for receiving data and for producing and using a fracture propagation model for use with equipment in the well system 100 of FIG. 1. In some examples, the components shown in FIG. 2 (e.g., the computing device 210, power source 220, and communications interface 230) can be integrated into a single structure. For example, the components can be within a single housing. In other examples, the components shown in FIG. 2 can be distributed (e.g., in separate housings) and in communication with each other. For example, the components can be part of a cloud computing system including multiple interconnected computing devices 210.

The computer system 200 includes a computing device 210. The computing device 210 can include a processor 202, a memory 240, and a bus 206. The processor 202 can execute one or more instructions for obtaining data associated with the fractures 122, borehole tube waves 114, the offset well 110, and the treatment well 120. The processor 202 can execute instructions stored in the memory 240 to perform the operations, for example, generating a fracture propagation model. The processor 202 can include one processing device or multiple processing devices. Non-limiting examples of the processor 202 include a Field-Programmable Gate Array (“FPGA”), an application-specific integrated circuit (“ASIC”), a microprocessor, etc.

The processor 202 can be communicatively coupled to the memory 240 via the bus 206. The non-volatile memory 240 can include any type of memory device that retains stored information when powered off. Non-limiting examples of the memory 240 include electrically erasable and programmable read-only memory (“EEPROM”), flash memory, or any other type of non-volatile memory. In some examples, at least part of the memory 240 can include a medium from which the processor 202 can read instructions. A non-transitory computer-readable medium can include electronic, optical, magnetic, or other storage devices capable of providing the processor 202 with computer-readable instructions or other program code. Non-limiting examples of a computer-readable medium include (but are not limited to) magnetic disk(s), memory chip(s), ROM, random-access memory (“RAM”), an ASIC, a configured processor, optical storage, or any other medium from which a computer processor can read instructions. The instructions can include processor-specific instructions generated by a compiler or an interpreter from code written in any suitable computer-programming language, including, for example, C, C++, C#, etc.

In some examples, the memory 240 can include computer program instructions for executing and using data to produce and operate a fracture propagation model for the arrival of fractures at a wellbore. As an illustrative example, the memory 240 can include computer program instructions for a model 242 that is a fracture propagation model, historical data 244, and a fracture-hit engine 246. The fracture-hit engine 246 can receive data from sensors 112 and generate the model 242 to predict the arrival time of future fractures 122 at the offset well 110. The historical data 244 can include data received from sensors 112 for previous stages of the treatment well 120 and the offset well 110, and can also be used to generate the model 242. Additionally or alternatively, the historical data 244 can include data from other wellbores near the well system 100 or wells that were drilled in areas with similar geological or seismic conditions.

The fracture-hit engine 246 can receive data from the sensors 112. The data received by the fracture-hit engine 246 can be data associated with borehole tube waves 114. For example, the data can include the time, location, and propagation speed of the borehole tube waves 114. In some examples, the data includes the time the borehole tube waves 114 are detected and a location is determined using data from other monitoring system (e.g., micro seismic monitoring). The fracture-hit engine 246 can use the data to determine the landing point of the fractures 122 on the offset well 110. The fracture-hit engine 246 can determine the time and location of the fracture initiation point 124 and the fracture landing point 126 The fracture initiation point 124 and fracture landing point 126 can be used to determine average fracture propagation speed. The average fracture propagation speed can be used with the model 242 to determine fracture arrival times for subsequent stages of the well or wells in the same or similar areas.

The computer system 200 can include a power source 220. The power source 220 can be in electrical communication with the computing device 210 and the communication interface 230. Communication interface 230 can be connected to wellbore equipment used for completion of the wellbore, for example, equipment used for hydraulic fracturing. In some examples, the power source 220 can include a battery or an electrical cable (e.g., a wireline). In some examples, the power source 220 can include an AC signal generator. The computing device 210 can operate the power source 220 to apply a signal to the communication interface 230 to operate the equipment used for wellbore completion with controllable parameters. For example, the computing device 210 can cause the power source 220 to apply a voltage with a frequency within a specific frequency range to the communication interface 230. In other examples, the computing device 210, rather than the power source 220, can apply the signal to communication interface 230.

The communication interface 230 of FIG. 2 can include, or can be coupled to, a wireless communication system to control equipment remotely. In some examples, part of the communication interface 230 can be implemented in software. For example, the communication interface 230 can include instructions stored in memory 240. The communication interface 230 can receive signals from remote devices and transmit data to remote devices. For example, the communication interface 230 can transmit wireless communications that are modulated by data. In some examples, the communication interface 230 can receive signals (e.g., associated with data to be transmitted) from the processor 202 and amplify, filter, modulate, frequency shift, and otherwise manipulate the signals.

The computer system 200 can also include input/output interface 250. Input/output interface 250 can connect to a keyboard, pointing device, display, and other computer input/output devices. An operator can provide input using the input/output interface 250. Such input can include a selected controllable parameter for a wellbore.

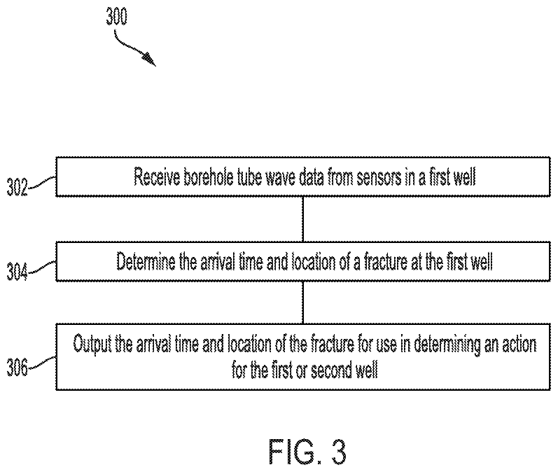

FIG. 3 is a flowchart of a process that can be implemented to detect fracture hits from fracturing operations according to some aspects. Some examples can include more, fewer, or different steps than the steps depicted in FIG. 3. Also, some examples can implement the steps of the process in a different order. For clarity, the steps of FIG. 3 described below are discussed with reference to the components of FIG. 1, but other implementations are possible.

In block 302, the computer system 130 receives data about borehole tube waves 114 in the offset well 110. The data can include information related to the time and location borehole tube waves 114 originated in the offset well 110. For example, the data can include a depth where a borehole tube wave 114 was first in the offset well 110. The information can additionally or alternatively include the time at which the borehole tube wave 114 originated. The time can be measured from the start of a treatment stage in the treatment well 120.

In some examples, the computer system 130 can receive data about borehole tube waves 114 from one or more sensors 112 positioned in the offset well 110. The data can include the time and location the borehole tube wave 114 was measured as it traveled in the offset well 114. The computer system 130 can use the time and location data for the borehole tube wave 114 to determine the time and location the borehole tube wave 114 originated in the offset well 110. For example, the computer system 130 can receive borehole tube wave 114 data from sensors 112. The computer system can map the data and identify the origination time and location of the borehole tube wave 114.

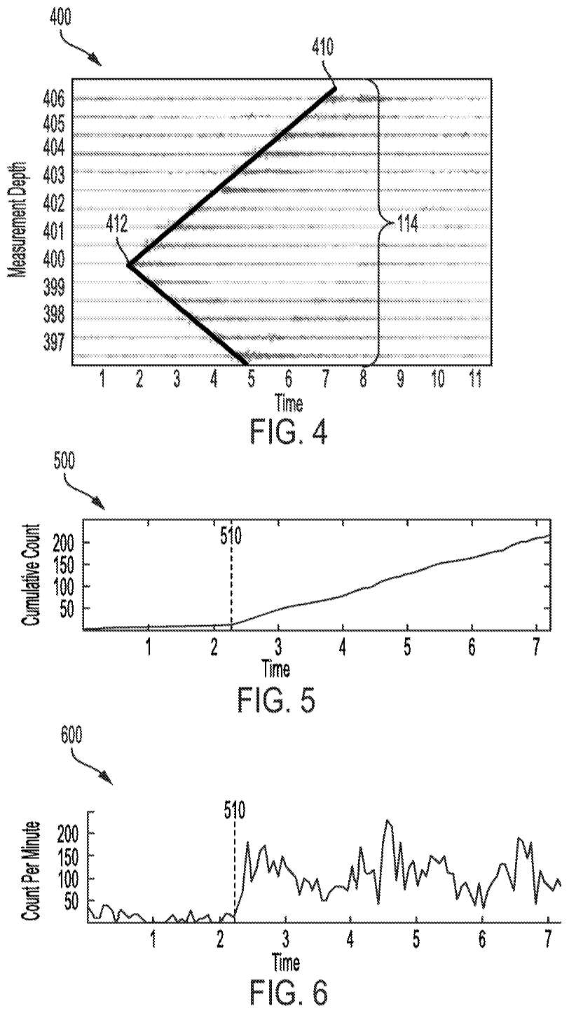

FIG. 4 shows a graph 400 that includes time and location data for a borehole tube wave 114 as it traveled in offset well 110. The Y-axis of the graph 400 can indicate the depth at which a sensor 112 was positioned in the offset well 110 the borehole tube wave 114 was measured. The X-axis can indicate the time elapsed from the start of a treatment stage in the treatment well 120.

Graph 400 shows the time and location of the borehole tube wave 114 traveling between a depth of 397 to 406 meters (approximately 1302 to 1332 feet). The time and location data has been graphed and connected via line 410. The connected data can be used to determine the origination time and location of the borehole tube wave 114. The connected data can form a “V” shape, with the tip of the “V” corresponding to the origination time and location of the borehole tube wave 114. The tip of the “V” corresponds to point 412 and is the origination time and location of the borehole tube wave 114.

In some examples, the computer system 130 can determine the approximate origination time of the borehole tube wave 114 using data from a single sensor 112A positioned in the offset well 110. The sensor 112A can be positioned in the offset well 110 at a known depth and can detect when a borehole tube wave 114 passes. For example, the sensor 112A can measure the time t when the borehole tube wave 114 passes. The origination time tₒ can be approximated by the measured time t of the borehole tube wave 114. The approximation error, t−t₀, is given by the formula: t−t₀=|d−d₀|/v, where |d−d₀| is the distance between the location of the sensor 112A and the origination location of the borehole tube wave 114, and v is the propagation speed of the borehole tube wave 114. In some examples, the distance between the location of the sensor 112A and the origination location of the borehole tube wave 114 and the propagation speed of the borehole tube wave 114 can result in an approximation error, t−t₀ that is less than a few seconds. The origination time of the borehole tube wave 114 obtained under such approximation is acceptable for the applications described in this disclosure.

Referring back to FIG. 3, in block 304, the computer system 130 determines the arrival of a fracture 122 at the offset well 110. The arrival of the fracture 122 can include the time and location the fracture 122 arrives at the offset well 110. The computer system 130 can determine the arrival of the fracture 122 using time and location data for multiple borehole tube waves 114 traveling in the offset well 110. The arrival of a fracture 122 at the offset well 110 can correspond to increased borehole tube wave activity in the offset well 110. For example, an increase in borehole tube waves 114 per minute or an increase in the total amount of borehole tube waves 114 detected in the offset well.

In some examples, the computer system 130 can determine the arrival time of the fracture 122 at the offset well 110. The arrival time of the fracture 122 can correspond to the leading edge of increased borehole tube wave activity. For example, the arrival time of a fracture 122 can be determined using a ramp-up on cumulative count vs time plot (FIG. 5) or a jump count per minute vs time plot (FIG. 6). The time at which the cumulative or jump count per minute greatly increases corresponds to the arrival time of the fracture 122 at the offset well 110.

The location of the fracture 122 arriving at the offset well 110 can correspond to the origination location of the borehole tube wave 114 that was measured at the identified arrival time of the fracture 122. For example, after determining the arrival time of the fracture 122, a borehole tube wave 114 that originated at the same time can be identified. The origination location of the identified borehole tube wave 114 corresponds to the arrival location of the fracture 122. In some examples, after determining the arrival time of the fracture 122, multiple borehole tube wave events can be identified, with their origination locations repeatedly at a certain location (or within a small spatial range). The repeating location (or the centroid of the small spatial range) corresponds to the arrival location of the fracture 122.

FIGS. 5 and 6 show graphs 500 and 600 that include data from multiple borehole tube waves 114 that have been detected in the offset well 110. Graphs 500 and 550 can be used to identify the fracture arrival time 510. Graph 500 can include the cumulative number of borehole tube waves 114 detected in the offset well 110 on the Y-axis and the time the borehole tube waves 114 were detected on the X-axis. The time at which the cumulative number of borehole tube waves 114 begins to steadily increase can be identified and can correspond to the fracture arrival time 510. Graph 600 can include the borehole tube waves 114 per minute on the Y-axis and the time the borehole tube waves 114 were detected on the X-axis. The time at which the count per minute can be identified and can correspond to the fracture arrival time 510.

Returning back to FIG. 3, in block 306, the computer system 130 can output the arrival time and location of the fracture 122 at the offset well 110. The arrival time and location of the fracture 122 can be used to determine an action for the offset well 110 or treatment well 120. For example, the arrival time and location of the fracture 122 can be used to generate a fracture propagation model for predicting the arrival times and locations of future fractures. Additionally or alternatively, mitigation actions can be taken in the offset well 110 or the treatment well 120. Examples of mitigation actions include changing the flow rate of fluid in the well, positioning equipment in the well, or modifying a completion plan for the well.

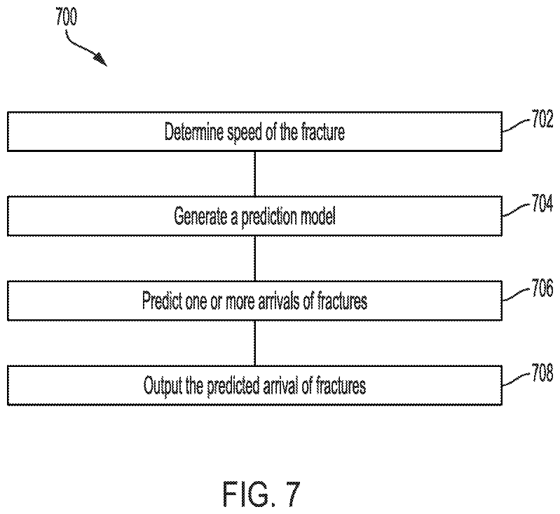

In some examples, the process shown in FIG. 7 can be used to generate a fracture propagation model for predicting future fractures arriving at the wellbore 110. The model can be generated by the computer system 130 using the arrival time and location of the fracture 122 at the offset well 110. Some examples can include more, fewer, or different steps than the steps depicted in FIG. 7. Also, some examples can implement the steps of the process in a different order. For clarity, the steps of FIG. 7 described below are discussed with reference to the components of FIG. 1, but other implementations are possible.

In block 702, the computer system 130 can determine the speed of the fracture 122 as it travels from the treatment well 120 to the offset well 110. The speed of the fracture 122 can be calculated using the arrival time and location (FLP) of the fracture 122 at the offset well 110 and the departure time and location (FIP) of the fracture 122 at the treatment well 120. The speed of the fracture 122 is equal to: (x_{FLP}−x_{FIP})/(t_{FLP}−t_{FIP}), where x is the location of the fracture 122 and t is the time since the start of the treatment stage in the treatment well 120.

The computer system 130 can determine the departure time and location of the fracture 122 using information related to hydraulic fracturing events occurring in the treatment well 120. For example, treatment pressure or injection rate data.

In block 704 and 706, the computer system 130 can generate a fracture propagation model for predicting future fractures 122. In some examples, the computer system 130 can use the calculated speed of the fracture 122 to generate the model. The model can predict the arrival time and location of future fractures at the offset well 110 using the known departure time and location of fractures at the treatment well 120. The model can predict a lower bound (the earliest arrival time) or an upper bound (the latest arrival time) for the arrival time of the fracture 122. Additionally or alternatively, the model can predict an exact arrival time of the fracture 122 at the offset well 110.

In some examples, the arrival times and locations of future fractures 122 can be predicted using data from multiple treatment stages of the treatment well 120. For example, the departure of fractures 122 from the treatment well 120 and the arrival of fractures 122 at the offset well 110 can be measured for the first ten stages of treatment in the treatment well 120. The arrival and departure data of the fractures 122 can be used with the model to predict the arrival of fractures at the offset well 110 in future treatment stages. The actual arrival of the fractures 122 at the offset well 110 in the future treatment stages can be measured and compared to the predicted arrival of the fractures 122 at the offset well 110. The actual arrival of the fractures 122 at the offset well 110 and the difference between the predicted and actual arrival of fractures at the offset well 110 can be used to further refine the model.

In some examples, the computer system 130 can use historical data with the model to predict the arrival of future fractures 122 at the offset well 110. For example, data about the arrival time and location of fractures 122 in past well systems 100 can be used with the model to predict the arrival time and location of fractures 122 in the present well system 100. The arrival time and location of fractures 122 can be determined using speed of past fractures 122 occurring in subterranean formations 102 with the same or similar geological properties.

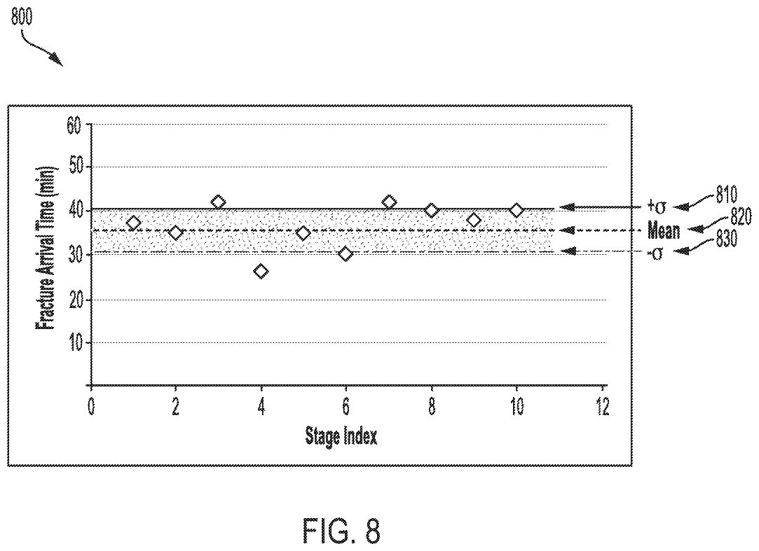

FIG. 8 shows a graph 800 with the measured arrival time of fractures 122 at the offset well 110. The Y-axis can include the arrival time of the fractures 122 since the start of the treatment stage of the treatment well 120. The X-axis can include the treatment stage of the treatment well 120. The arrival time of fractures 122 at the offset well 110 have been measured for the first ten treatment stages of the treatment well 120. The arrival times of the fractures 122 have a mean 820 of thirty-five minutes, an upper bound 810 of forty minutes and a lower bound 830 of thirty minutes. The computer system 130 can use the measured arrival times of the fractures 122 in the first ten stages with the model to predict the arrival time of fractures 122 in future stages.

Returning to FIG. 7, at block 708, the computer system 130 can output the predicted arrival time of the fractures 122 at the offset well 110. The predicted arrival times can be used to take preventative actions in the offset well 110 or the treatment well 120. For example, the predicted arrival time for a fracture 122 at the offset well 110 can be used to adjust the hydraulic fracture occurring in the treatment well 120. The preventative actions can include one or more of changing a flow rate or fluid flow amount for a future fracturing action in the treatment well 120; positioning equipment or fluid in the offset well 110 at a location predicted to receive one or more borehole tube waves 114; or modifying a completion plan for the offset well 110.

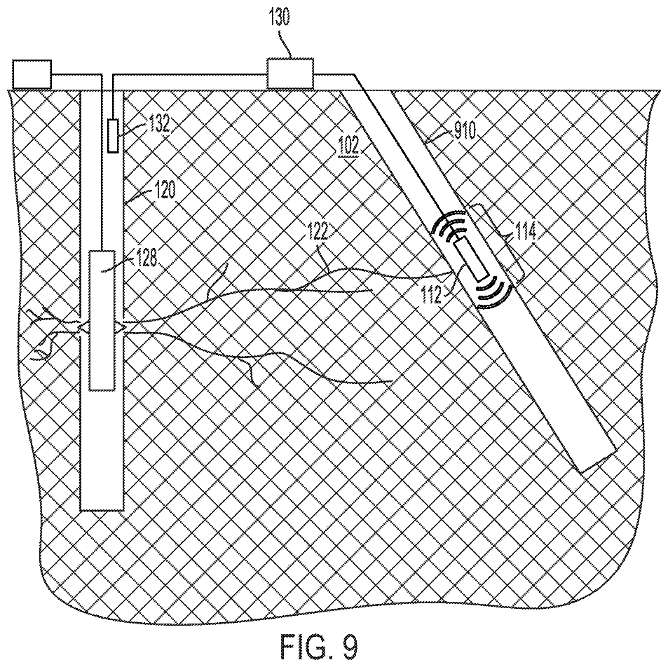

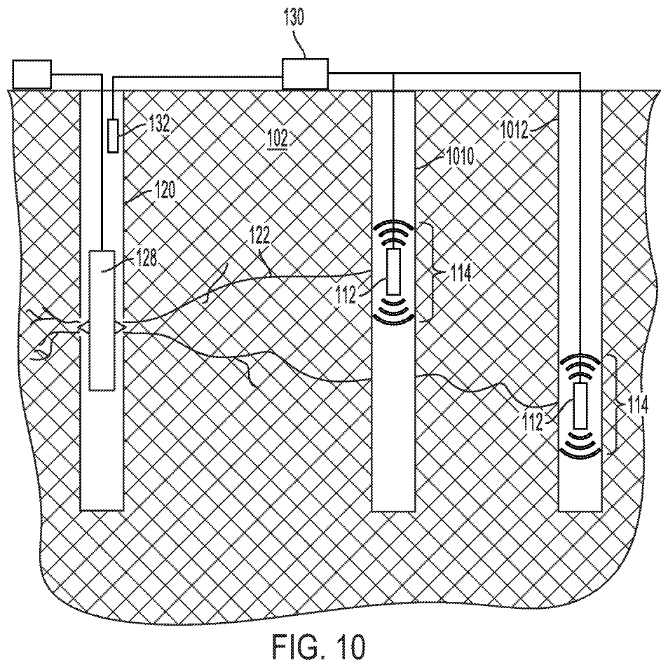

FIGS. 9 and 10 are examples of offset wellbore 110. FIG. 9 includes a treatment well 120 and an oblique offset well 910. The oblique offset well 910 can be a variable distance away from the treatment well 120 based on the depth of the well. For example, as the depth increases, the oblique well 910 can be a greater distance away from the treatment well 120. The variable distance can result in variable arrival times for fractures 122 at the oblique well 910. A linear regression can be applied to the arrival time of fractures 122 for the oblique well 910 to determine an average arrival time of fractures 122 at the oblique well 910. The computer system 130 can use the average arrival time to determine an average speed of the fractures 122 arriving at the oblique well 910. Alternatively, a non-linear curve fitting can be applied to the variable distance versus variable arrival times of fractures 122 for the oblique well 910 to build a non-linear prediction model 704. The non-linear prediction model 704 can be used to make predictions about fractures arrival times 706.

FIG. 10 includes a treatment well 120, a first offset well 1010, and a second offset well 1012. The first offset well 1010 is located closer to the treatment well 120 than the second offset well 1012. The arrival time of fractures 122 can be measured at the first offset well 1010 and the second offset well 1012. The computer system 130 can generate a model using the arrival time at the first offset well 1010 and the arrival time at the second offset well 1012.

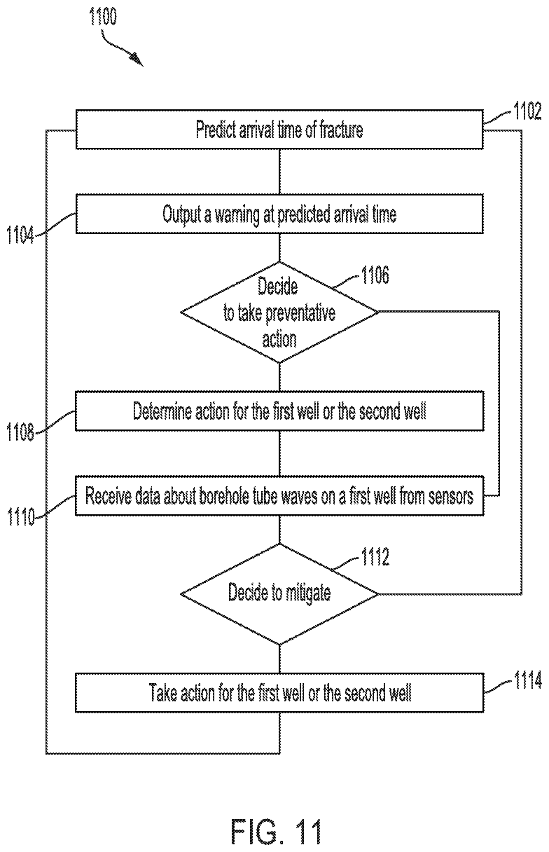

FIG. 11 includes a workflow process 1100 for use with the systems and processes described above. At block 1102, the computer system 130 predicts the arrival of fractures 122 at the offset well 110 using the model described in process 700. At block 1104, the computer system outputs a warning at or before the predicted arrival time. The warning can include displaying a warning message, playing a warning sound or tone, or a combination of displaying a warning message and playing a warning sound.

At block 1106, the computer system 130 or a user can take preventative action based on the predicted arrival of fractures 122 at the offset well 110. For example, after receiving a warning message a user can decide to take action for the treatment well 120 or the offset well 110. At block 1108, the computer system 130 can determine which action or action to take for the treatment well 120 or the offset well 110. The actions can include those taken in process 300 or 700. However, the actions can include additional or alternative actions.

At block 1110, the computer system 130 receives data about borehole tube waves in the offset well 110. The data can include the time and location of the borehole tube wave 114 in the offset well 110. The data can be used with process 300 to determine the arrival time and location of fractures 122 at the offset well 110. The arrival time and location of the fractures 122 can be used with process 700 to determine the speed of the fractures 122 and generate or refine a model.

At block 1112, the computer system 130 or the user can determine whether mitigation actions should be taken based on data associated with the borehole tube waves 114 or the fractures 122. At block 1114, the computer system or the user can take mitigating action for the treatment well 120 or the offset well 110. The process 1100 can be repeated for additional stages of the treatment well 120 or for additional well systems 100.

In some aspects, apparatuses and a method for measuring fracture-hit arrival time in wellbore operations.

As used below, any reference to a series of examples is to be understood as a reference to each of those examples disjunctively (e.g., “Examples 1-4” is to be understood as “Examples 1, 2, 3, or 4”).

Example 1 is a system comprising: one or more sensors positionable in a first well to detect data about a plurality of borehole tube waves on the first well that are from one or more events in a second well, the data including time information for fracture hits associated with the plurality of borehole tube waves; a computing device comprising a processor and a non-transitory computer-readable medium having instructions stored thereon that are executable by the processor to cause the computing device to: receive the data from the one or more sensors; determine, using the data, one or more arrivals for the fracture hits associated with the plurality of borehole tube waves for the first well; and output the one or more arrivals for the fracture hits for use in determining an action for the first well or the second well.

Example 2 is the system of example(s) 1, wherein the instructions stored on the non-transitory computer-readable medium that are executable by the processor to cause the computing device to determine, using the data, the one or more arrivals for the fracture hits associated with the plurality of borehole tube waves for the first well, includes instructions that are executable to cause the computing device to: determine one or more fracture propagation speeds for fractures from the second well to the first well; and generate, using the one or more fracture propagation speeds, a fracture propagation model for predicting future fracture hits.

Example 3 is the system of example(s) 2, wherein the instructions stored on the non-transitory computer-readable medium that are executable by the processor to cause the computing device to determine, using the data, the one or more arrivals for the fracture hits associated with the plurality of borehole tube waves for the first well, includes instructions that are executable to cause the computing device to: predict, using the fracture propagation model, one or more arrivals for future fractures in subsequent stages of the second well, wherein the instructions stored on the non-transitory computer-readable medium that are executable by the processor to cause the computing device to output the one or more arrivals for the fracture hits for use in determining the action for the first well or the second well, includes instructions that are executable to cause the computing device to output the one or more predicted arrivals for future fractures for use in determining the action for the first well or the second well.

Example 4 is the system of example(s) 3, wherein the action for the first well or the second well includes at least one of: changing a flow rate or fluid flow amount for a future fracturing action in the second well; positioning equipment or fluid in the first well at a location predicated to receive one or more future borehole tube waves; or modifying a completion plan for the first well.

Example 5 is the system of example(s) 2, wherein the instructions stored on the non-transitory computer-readable medium that are executable by the processor to cause the computing device to generate, using the one or more fracture speeds, the fracture propagation model for predicting future borehole tube waves, includes instructions that are executable by the processor to cause the computing device to: detect a distance between a stage of the second well in which an event occurred and a location of the first well for the fracture hits associated with the plurality of borehole tube waves; and generate the fracture propagation model using the distance.

Example 6 is the system of example(s) 5, wherein the instructions are executable by the processor to cause the computing device to predict, using the fracture propagation model, one or more arrivals for subsequent borehole tube waves on a third well from the one or more events in the second well or subsequent events in a fourth well, wherein the first well, the second well, the third well, and the fourth well are positionable in a common oilfield area.

Example 7 is the system of example(s) 1, wherein the instructions are executable by the processor to cause the computing device to: receive information about the one or more events in the second well from a sensor system positionable in the second well, the information including an amount of fluid exiting the second well during the one or more events; and outputting the information for use in determining the action for the first well or the second well.

Example 8 is a method comprising: receiving, from one or more sensors, data about a plurality of borehole tube waves on a first well that are from one or more events in a second well, the data including time information for fracture hits associated with the plurality of borehole tube waves; determining, using a computing device and the data, one or more arrivals for the fracture hits associated with the plurality of borehole tube waves for the first well; and outputting the one or more arrivals for use in determining an action for the first well or the second well.

Example 9 is the method of example(s) 8, wherein determining, using the computing device and the data, the one or more arrivals for the fracture hits associated with the plurality of borehole tube waves for the first well comprises: determining one or more fracture speeds for the plurality of borehole tube waves for the first well using the data and arrivals for the one or more events in the second well; generating, using the one or more fracture speeds, a fracture propagation model for predicting future borehole tube waves; and predicting, using the fracture propagation model, one or more arrivals for future fractures in subsequent stages of the second well, wherein outputting the one or more arrivals for use in determining the action for the first well or the second well comprises outputting the one or more predicted arrivals for future fractures for use in determining the action for the first well or the second well.

Example 10 is the method of example(s) 9, wherein the action for the first well or the second well includes at least one of: changing a flow rate or fluid flow amount for a future fracturing action in the second well; positioning equipment or fluid in the first well at a location predicated to receive one or more future borehole tube waves; or modifying a completion plan for the first well.

Example 11 is the method of example(s) 9, wherein generating, using the one or more fracture speeds, the fracture propagation model for predicting the future borehole tube waves comprises: detecting a distance between a stage of the second well in which an event occurred and a location of the first well for the fracture hits associated with the plurality of borehole tube waves; and generating the fracture propagation model using the distance.

Example 12 is the method of example(s) 11, further comprising: predicting, using the fracture propagation model, the one or more arrivals for future events in one or more subsequent stages of the second well and in one or more subsequent stages of a third well, wherein the one or more events in the second well are fracture events.

Example 13 is the method of example(s) 9, further comprising: predicting, using the fracture propagation model, one or more arrival times for subsequent borehole tube waves on a third well from subsequent events in a fourth well, wherein the first well, the second well, the third well, and the fourth well are in a common oilfield area.

Example 14 is the method of example(s) 8, further comprising: receiving information about the one or more events in the second well from a sensor system positioned in the second well, the information including an amount of fluid exiting the second well during the one or more events; and using the information to determine the action for the first well or the second well.

Example 15 is a non-transitory computer-readable medium having instructions stored thereon that are executable by a processor to perform operations, the operations comprising: receiving, from one or more sensors, data about a plurality of borehole tube waves on a first well that are from one or more events in a second well, the data including time information for fracture hits associated with the plurality of borehole tube waves; determining, using the data, one or more arrivals for the fracture hits associated with the plurality of borehole tube waves for the first well; and outputting the one or more arrivals for use in determining an action for the first well or the second well.

Example 16 is the non-transitory computer-readable medium of example(s) 15, wherein the operations of determining, using the data, the one or more fracture hits associated with the plurality of borehole tube waves for one or more stages of the second well includes the operations of: determining one or more fracture speeds for the plurality of borehole tube waves for one or more stages of the second well using the data and arrivals for the one or more events in the second well; generating, using the one or more fracture speeds, a fracture propagation model for predicting future borehole tube waves; and predicting, using the fracture propagation model, one or more arrival times for future borehole tube waves from future fractures in subsequent stages of the second well, wherein the operations of outputting the one or more arrivals for use in determining the action for the first well or the second well includes the operations of outputting the one or more predicted arrival times for future borehole tube waves for use in determining the action for the first well or the second well.

Example 17 is the non-transitory computer-readable medium of example(s) 16, wherein the action for the first well or the second well includes at least one of: changing a flow rate or fluid flow amount for a future fracturing action in the second well; positioning equipment or fluid in the first well at a location predicated to receive one or more future borehole tube waves; or modifying a completion plan for the first well.

Example 18 is the non-transitory computer-readable medium of example(s) 16, wherein the operations of generating, using the one or more fracture speeds, the fracture propagation model for predicting the future borehole tube waves, includes the operations of: detecting a distance between a stage of the second well in which an event occurred and a location of the first well for fracture hits associated with the plurality of borehole tube waves; and generating the fracture propagation model using the distance.

Example 19 is the non-transitory computer-readable medium of example(s) 18, wherein the operations further include: predicting, using the fracture propagation model, the one or more arrival times for future fractures in one or more subsequent stages of the second well and in one or more subsequent stages of a third well, wherein the one or more events in the second well are fracture events.

Example 20 is the non-transitory computer-readable medium of example(s) 16, wherein the operations further include: predicting, using the fracture propagation model, one or more arrival times for subsequent borehole tube waves on a third well from subsequent events in a fourth well, wherein the first well, the second well, the third well, and the fourth well are in a common oilfield area.

Example 21 is the system of example(s) 1, wherein the one or more sensors include a first sensor positionable uphole to a location of the fracture hits and a second sensor positionable downhole to the location of the fracture hits.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
one or more sensors positionable in a first well to detect data about a plurality of borehole tube waves on the first well that are from one or more events in a second well, the data including time information for fracture hits associated with the plurality of borehole tube waves;
a computing device comprising a processor and a non-transitory computer-readable medium having instructions stored thereon that are executable by the processor to cause the computing device to:
receive the data from the one or more sensors;
determine, using the data, one or more arrivals for the fracture hits associated with the plurality of borehole tube waves for the first well; and
output the one or more arrivals for the fracture hits for use in determining an action for the first well or the second well.

2. The system of claim 1, wherein the instructions stored on the non-transitory computer-readable medium that are executable by the processor to cause the computing device to determine, using the data, the one or more arrivals for the fracture hits associated with the plurality of borehole tube waves for the first well, includes instructions that are executable to cause the computing device to:
determine one or more fracture propagation speeds for fractures from the second well to the first well; and
generate, using the one or more fracture propagation speeds, a fracture propagation model for predicting future fracture hits.

3. The system of claim 2, wherein the instructions stored on the non-transitory computer-readable medium that are executable by the processor to cause the computing device to determine, using the data, the one or more arrivals for the fracture hits associated with the plurality of borehole tube waves for the first well, includes instructions that are executable to cause the computing device to:
predict, using the fracture propagation model, one or more arrivals for future fractures in subsequent stages of the second well, wherein the instructions stored on the non-transitory computer-readable medium that are executable by the processor to cause the computing device to output the one or more arrivals for the fracture hits for use in determining the action for the first well or the second well, includes instructions that are executable to cause the computing device to output the one or more predicted arrivals for future fractures for use in determining the action for the first well or the second well.

4. The system of claim 3, wherein the action for the first well or the second well includes at least one of:
changing a flow rate or fluid flow amount for a future fracturing action in the second well;
positioning equipment or fluid in the first well at a location predicated to receive one or more future borehole tube waves; or
modifying a completion plan for the first well.

5. The system of claim 2, wherein the instructions stored on the non-transitory computer-readable medium that are executable by the processor to cause the computing device to generate, using the one or more fracture speeds, the fracture propagation model for predicting future borehole tube waves, includes instructions that are executable by the processor to cause the computing device to:
detect a distance between a stage of the second well in which an event occurred and a location of the first well for the fracture hits associated with the plurality of borehole tube waves; and
generate the fracture propagation model using the distance.

6. The system of claim 5, wherein the instructions are executable by the processor to cause the computing device to predict, using the fracture propagation model, one or more arrivals for subsequent borehole tube waves on a third well from the one or more events in the second well or subsequent events in a fourth well, wherein the first well, the second well, the third well, and the fourth well are positionable in a common oilfield area.

7. The system of claim 1, wherein the instructions are executable by the processor to cause the computing device to:
receive information about the one or more events in the second well from a sensor system positionable in the second well, the information including an amount of fluid exiting the second well during the one or more events; and
outputting the information for use in determining the action for the first well or the second well.

8. A method comprising:
receiving, from one or more sensors, data about a plurality of borehole tube waves on a first well that are from one or more events in a second well, the data including time information for fracture hits associated with the plurality of borehole tube waves;
determining, using a computing device and the data, one or more arrivals for the fracture hits associated with the plurality of borehole tube waves for the first well; and
outputting the one or more arrivals for use in determining an action for the first well or the second well.

9. The method of claim 8, wherein determining, using the computing device and the data, the one or more arrivals for the fracture hits associated with the plurality of borehole tube waves for the first well comprises:
determining one or more fracture speeds for the plurality of borehole tube waves for the first well using the data and arrivals for the one or more events in the second well;
generating, using the one or more fracture speeds, a fracture propagation model for predicting future borehole tube waves; and
predicting, using the fracture propagation model, one or more arrivals for future fractures in subsequent stages of the second well, wherein outputting the one or more arrivals for use in determining the action for the first well or the second well comprises outputting the one or more predicted arrivals for future fractures for use in determining the action for the first well or the second well.

10. The method of claim 9, wherein the action for the first well or the second well includes at least one of:
changing a flow rate or fluid flow amount for a future fracturing action in the second well;
positioning equipment or fluid in the first well at a location predicated to receive one or more future borehole tube waves; or
modifying a completion plan for the first well.

11. The method of claim 9, wherein generating, using the one or more fracture speeds, the fracture propagation model for predicting the future borehole tube waves comprises:
detecting a distance between a stage of the second well in which an event occurred and a location of the first well for the fracture hits associated with the plurality of borehole tube waves; and
generating the fracture propagation model using the distance.

12. The method of claim 11, further comprising:
predicting, using the fracture propagation model, the one or more arrivals for future events in one or more subsequent stages of the second well and in one or more subsequent stages of a third well, wherein the one or more events in the second well are fracture events.

13. The method of claim 9, further comprising:
predicting, using the fracture propagation model, one or more arrival times for subsequent borehole tube waves on a third well from subsequent events in a fourth well, wherein the first well, the second well, the third well, and the fourth well are in a common oilfield area.

14. The method of claim 8, further comprising:
receiving information about the one or more events in the second well from a sensor system positioned in the second well, the information including an amount of fluid exiting the second well during the one or more events; and
using the information to determine the action for the first well or the second well.

15. A non-transitory computer-readable medium having instructions stored thereon that are executable by a processor to perform operations, the operations comprising:
receiving, from one or more sensors, data about a plurality of borehole tube waves on a first well that are from one or more events in a second well, the data including time information for fracture hits associated with the plurality of borehole tube waves;
determining, using the data, one or more arrivals for the fracture hits associated with the plurality of borehole tube waves for the first well; and
outputting the one or more arrivals for use in determining an action for the first well or the second well.

16. The non-transitory computer-readable medium of claim 15, wherein the operations of determining, using the data, the one or more fracture hits associated with the plurality of borehole tube waves for one or more stages of the second well includes the operations of:
determining one or more fracture speeds for the plurality of borehole tube waves for one or more stages of the second well using the data and arrivals for the one or more events in the second well;
generating, using the one or more fracture speeds, a fracture propagation model for predicting future borehole tube waves; and
predicting, using the fracture propagation model, one or more arrival times for future borehole tube waves from future fractures in subsequent stages of the second well,
wherein the operations of outputting the one or more arrivals for use in determining the action for the first well or the second well includes the operations of outputting the one or more predicted arrival times for future borehole tube waves for use in determining the action for the first well or the second well.

17. The non-transitory computer-readable medium of claim 16, wherein the action for the first well or the second well includes at least one of:
changing a flow rate or fluid flow amount for a future fracturing action in the second well;
positioning equipment or fluid in the first well at a location predicated to receive one or more future borehole tube waves; or
modifying a completion plan for the first well.

18. The non-transitory computer-readable medium of claim 16, wherein the operations of generating, using the one or more fracture speeds, the fracture propagation model for predicting the future borehole tube waves, includes the operations of:
detecting a distance between a stage of the second well in which an event occurred and a location of the first well for fracture hits associated with the plurality of borehole tube waves; and
generating the fracture propagation model using the distance.

19. The non-transitory computer-readable medium of claim 18, wherein the operations further include:
predicting, using the fracture propagation model, the one or more arrival times for future fractures in one or more subsequent stages of the second well and in one or more subsequent stages of a third well, wherein the one or more events in the second well are fracture events.

20. The non-transitory computer-readable medium of claim 16, wherein the operations further include:
predicting, using the fracture propagation model, one or more arrival times for subsequent borehole tube waves on a third well from subsequent events in a fourth well, wherein the first well, the second well, the third well, and the fourth well are in a common oilfield area.
